(19) United States
(12) Patent Application Publication
(10) Pub. No.: US 2025/0107507 A1
(43) Pub. Date: Apr. 3, 2025

(54) INTERCHANGEABLE PET TOY

(71) Applicant: Chewsy Pets, LLC, Monument, CO (US)

(72) Inventor: Maximillian Bekhit, Monument, CO (US)

(21) Appl. No.: 18/479,857

(22) Filed: Oct. 3, 2023

(51) Int. Cl. A01K 15/02

(52) U.S. Cl. CPC A01K 15/026

(57) ABSTRACT

An interchangeable pet toy is disclosed. An example interchangeable pet toy includes a connector body having at least one looped connection. The interchangeable pet toy also includes a first toy or accessory having a first looped end portion, and a second toy or accessory having a second looped end portion. The first looped end portion of the first pet toy feeds through and interconnects with the at least one looped connection of the connector body to secure the first toy or accessory to the connector body. The first looped end portion of the first toy or accessory is removed from the connector body for replacement with the second toy or accessory. The connector body is interchangeable with a plurality of different toys or accessories.

### RELATED PATENT APPLICATION

This application is related to co-owned U.S. patent application Ser. No. 17/657,778, filed Apr. 4, 2022 (Published as US-2022-0312737 on Oct. 6, 2022) for “Pet Chew Toy” of Maximillian Bekhit, et al.

### BACKGROUND

Spending for the pet industry reached nearly 100 billion dollars by 2020. A large portion of this spending is on pet toys and other devices to entertain pets. Many pet toys are basic in structure, and lose their novelty for the pet in a short amount of time. As such, the pet may chew on rugs, furniture, or other household items even when there are several pet toys available for the pet. In addition, many pet toys do not last long when chewed by dogs and other pets. Many of these pet toys easily come apart during play and have to be thrown out and replaced.

### BRIEF DESCRIPTION OF THE DRAWINGS

FIG. 1 shows an example of an interchangeable pet toy.

FIG. 2 shows the example interchangeable pet toy of FIG. 1 as it may be connected in a daisy-chain with another example interchangeable pet toy.

FIGS. 3-6 show example connector bodies of an interchangeable pet toy.

FIG. 7 shows examples of other toys or accessories which may be provided for the interchangeable pet toy.

FIGS. 8 and 9 show an example of another interchangeable pet toy with an interconnection member.

FIG. 10 shows the example interchangeable pet toy of FIGS. 8 and 9 as it may be connected in a daisy-chain with another example interchangeable pet toy.

### DETAILED DESCRIPTION

An interchangeable pet toy is disclosed as it may include a connector body and one or more toys or accessories that can be readily attached to the connector body, and then detached and replaced with other toys or accessories. As such, the interchangeable pet toy provides variation for the dog or other pet, as well as easy replacement of the toys or accessories as these are worn out over time.

An example interchangeable pet toy includes a connector body having at least one looped connection. The interchangeable pet toy also includes one or more toy or accessory having a looped end portion. The looped end portions of the toy or accessory feeds through and interconnects with the looped connection of the connector body to secure the toy or accessory to the connector body. The looped end portion of the toy or accessory can be removed from the connector body for replacement with another toy or accessory. The connector body is interchangeable with a variety of different toys or accessories, thereby providing variation and easy replacement of worn or broken toys or accessories.

In an example, the interchangeable pet toy may be made of durable, safe-to-chew materials, and provides a modular, customizable pet toy. The example interchangeable pet toy may be configured for easy, quick attachment of toys and accessories (e.g., plush toys, ropes, hard rubber chew toys, etc.) via the unique looped interconnection. Any toys and/or accessories that are suitable for pet play and entertainment may be provided. In an example, the interchangeable pet toy may be provided with a handle that is strong enough for human interactive play with the pet (e.g., tug-of-war, etc).

One of the primary advantages of this invention is the efficiency it brings to the manufacturing process. The toy's modular design and the quick attachment system allow for rapid assembly and customization by the end-user, thus meeting individual customer preferences. By streamlining the manufacturing process, the interchangeable pet toy enables the creation of tailor-made toys for pets, providing a unique and engaging experience.

Furthermore, the attachment system of the interchangeable pet toy ensures the durability required to withstand regular pet chewing. The design accounts for the wear and tear associated with such activities, ensuring the longevity of the attached accessories. Additionally, the attachment system is designed to be safe for pets. The selected accessories and the attachments themselves are soft and pet-friendly, prioritizing the well-being of the animals during playtime.

In summary, a novel and inventive dog toy that solves the problems of customization, secure attachment, durability, and safety. The efficient manufacturing process, strong attachment system, durable construction, and safe materials combine to create an exceptional product that enhances the play experience for pets and provides a customizable solution for pet owners.

Before continuing, it is noted that as used herein, the terms “includes” and “including” mean, but is not limited to, “includes” or “including” and “includes at least” or “including at least.” The term “based on” means “based on” and “based at least in part on.” In addition the term “chew” refers to the toy being suitable for a pet to chew and/or grasp with the pet's teeth, and is not limited to being used only with toys that the pet must chew on such as chewing its food.

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

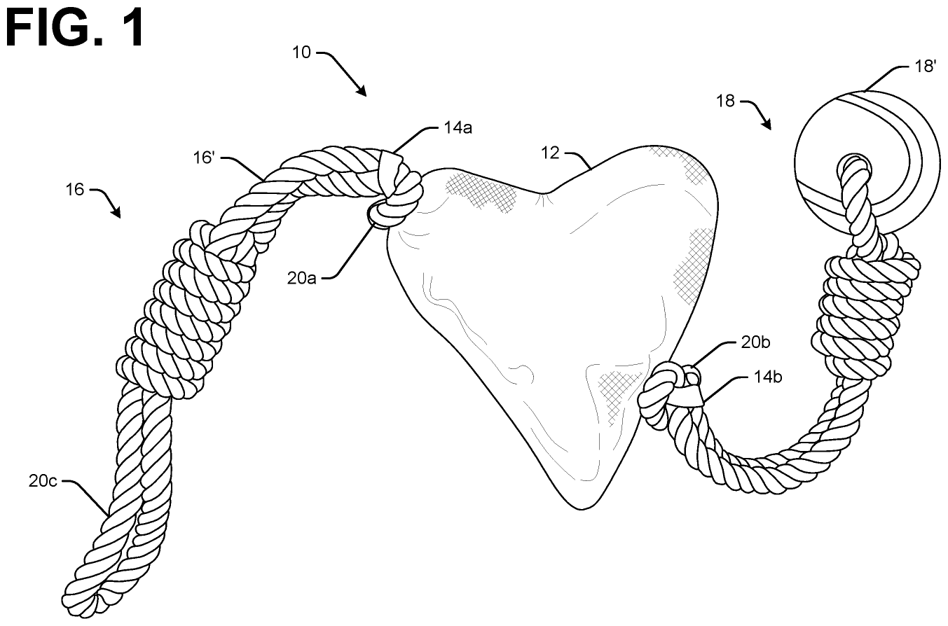

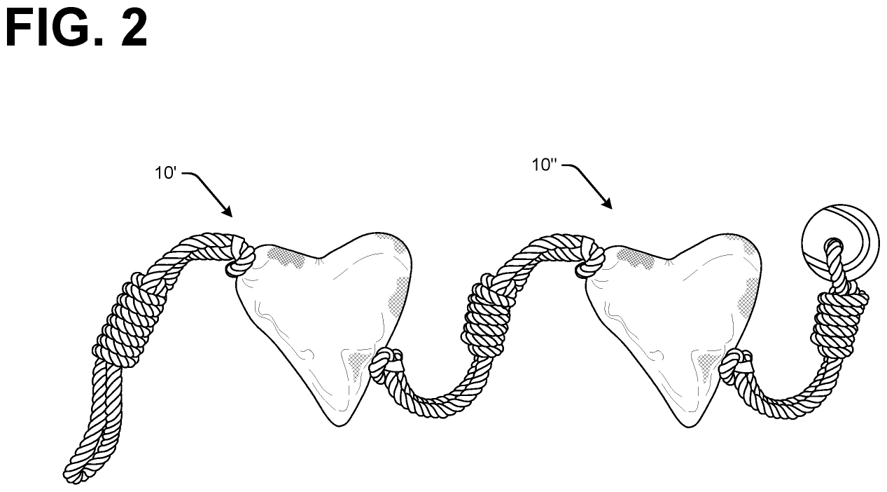

FIG. 1 shows an example of an interchangeable pet toy 10. FIG. 2 shows the example interchangeable pet toy of FIG. 1 as it may be connected in a daisy-chain with another example interchangeable pet toy. It is noted that the shapes and configurations shown in the drawings are merely illustrative and not intended to be limiting in any regard. Other examples of connector bodies and toys or accessories are also contemplated as being within the scope of the disclosure, as will be readily understood by those having ordinary skill in the art after becoming familiar with the teachings herein. The scope of the claims is not intended to be limited to these illustrations.

An example interchangeable pet toy 10 includes a connector body 12 having at least one looped connection. Two looped connections 14a and 14b are shown in FIG. 1, however, the connector body 12 may have one, two, or more looped connections. In addition, the looped connections 14a and 14b may be placed in any suitable position(s) on the connector body 12. The looped connections 14a and 14b provide location(s) for attaching one or more toy or accessory 16 and 18 via looped end portion(s) 20a-c. The connector body 12 enables a modular, interchangeable pet toy by being able to attach and detach and thereby replace a toy or accessory 16 on the connector body with another (e.g., a different type and/or new) toy or accessory 18.

In an example, the looped connections 14a and 14b are each specially configured to removably interconnect to the looped end portion(s) 20a-c. For example, the looped end portions 20a-c of the toy or accessory 16, 18 may be passed or “fed” through the looped connections 14a, 14b of the connector body 12. The looped end portions 20a-c interconnect with the looped connections 14a, 14b to secure the toy or accessory 16, 18 to the connector body 12. The looped end portion 20a-c of the toy or accessory 16, 18 can be removed from the connector body 12 for replacement with another toy or accessory 16, 18. The connector body 12 is interchangeable with a variety of different toys or accessories 16, 18 (those shown, and others), thereby providing variation and easy replacement of worn or broken toys or accessories 16, 18.

Any suitable toys and/or accessories may be provided. In an example, the connector body 12 of the interchangeable pet toy 10 is configured to be attached to and interchanged with a variety of different soft, plush toys, and/or an assortment of accessories 18, 19. In an example, a handle portion 20 is provided for human engagement with the interchangeable pet toy 10, such as for tug-of-war between a person and their pet. As such, the interchangeable pet toy 10 is customizable and modular.

In an example, the connector body 12 enables easy, quick attachment and interchanging of complementary toys or accessories 16, 18. As such, the interchangeable pet toy 10 connects to toys or accessories 16, 18 that are safe for the pet to hold in its mouth and chew on, while the connector body 12 itself also being safe to chew on by the pet. Additionally, the interchangeable pet toy 10 can hold a strong enough attachment for general play with the pet (e.g., tug-of-war).

In FIG. 1, an example interchangeable pet toy 10 is shown including a connector body 12 having at least one looped connection 14a, 14b. A first toy or accessory 16 is shown having looped end portions 20a, 20c on opposite ends. A second toy or accessory 18 is shown having a looped end portion 20b. The looped end portion 20a of the first pet toy or accessory 16 is connected by extending the loop through the looped connection 14a of the connector body 12, thereby interconnecting with each other to secure the first toy or accessory 16 to the connector body 12. Likewise, the looped end portion 20b of the second pet toy or accessory 18 is connected by extending the loop through the looped connection 14b of the connector body 12, thereby interconnecting with each other to secure the second toy or accessory 18 to the connector body 12. The looped end portions 20a and 20b may be removed from the connector body 12 so that the toys or accessories 16, 18 can be replaced with another (e.g., a new and/or different) toy or accessory (those shown and/or others).

The toys or accessories may have any suitable design and/or configuration. Likewise, the connector body 12 may be implemented with a variety of different types and/or designs of toys or accessories.

The example toy or accessory 16 is shown in FIG. 1 having two looped end portions 20a, 20c. The toy or accessory 18 is shown in FIG. 1 having one looped end portion 20b, and a ball 18′. The ball 18′ may be a tennis ball, rubber ball, or any other ball (or other object, such as a square, triangle, etc.) suitable for a pet to chew and/or pull on.

The toy or accessory 16, 18 may be made of any suitable material(s). In FIG. 1, the toy or accessory 16, 18 is made of a sturdy rope (suitable for a dog to chew and/or pull on). Referring specifically to toy or accessory 16, the rope 16′ forms looped end portions 20a and 20c on opposite ends, and is wound/tied in a knot in the middle. This embodiment may be implemented as a toy. For example, the pet may chew and pull on the knot in the middle and/or the looped end portion 20c. This embodiment may also serve as an accessory, such as a handle for a person to hold onto, e.g., while playing tug of war with the pet.

The interchangeable pet toy 10 may be configured in a variety of different manners. For example, the interchangeable pet toy 10 may include one or more connector body 12, one or more toy or accessory 16, 18, and/or one or more attachment for the connector body 12 and/or toy or accessory 16, 18.

In an example, the interchangeable pet toy 10 includes a first connector body having at least a first looped connection 14a and a second looped connection 14b. A plurality of toys or accessories 18 (e.g., rope with ball 18′) are provided. Any of a wide variety of toys or accessories may be provided. Each of the toys or accessories 18 have a looped end portion 20b to connect the toys or accessories 18 to the connector body 12. In FIG. 1, toys or accessories 18 are shown connected to the second looped connection 14b of the connector body 12.

Also in this example, at least one extension 16 may be provided. The extension 16 may include a plurality of looped end portions (e.g., looped end portions 20a, 20c on each side of the rope). The extension 16 may thus be connected between the second looped connection of a first connector body, and a looped connection of another (second) connector body (not shown), thereby linking multiple connector bodies together. It is understood (though not shown) that any number of connector bodies may be linked together in this manner, and may be provided with any number of toys or accessories.

It is noted that the connector bodies may have more than two looped connections (not shown), enabling toys or accessories to be provided on connector bodies that are connected on each end (e.g., at 14a, 14b) to extensions. The connector bodies are interchangeable with any number of extensions and a plurality of different connector bodies and/or different types of toys or accessories. Likewise, the toys or accessories may be, and even the extension(s), may be removed from the connector body or bodies to replace the toys or accessories (and/or extensions) with other toys or accessories (and/or extensions). This feature may be utilized to replace broken or worn components and/or to provide a different toy experience for the pet.

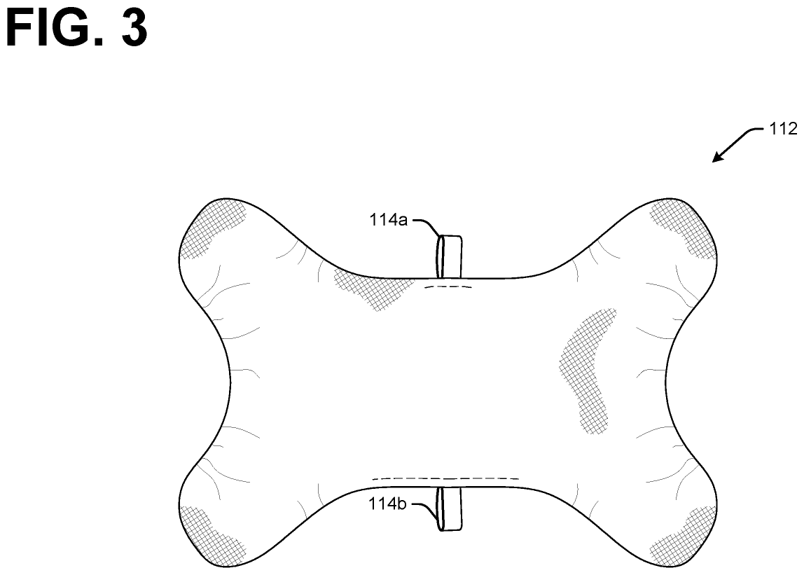

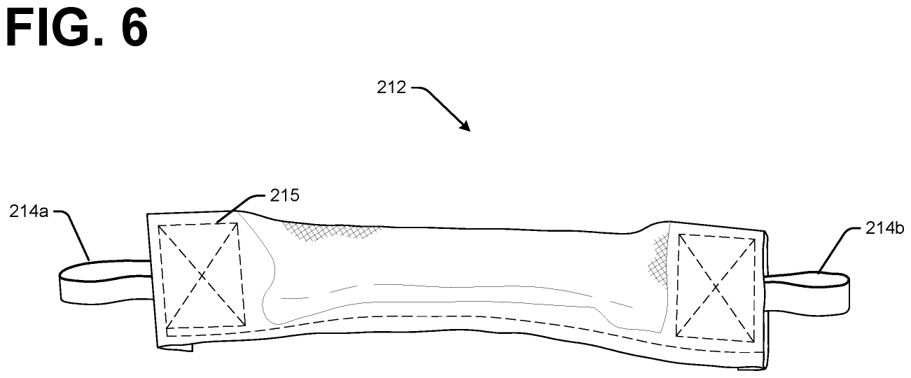

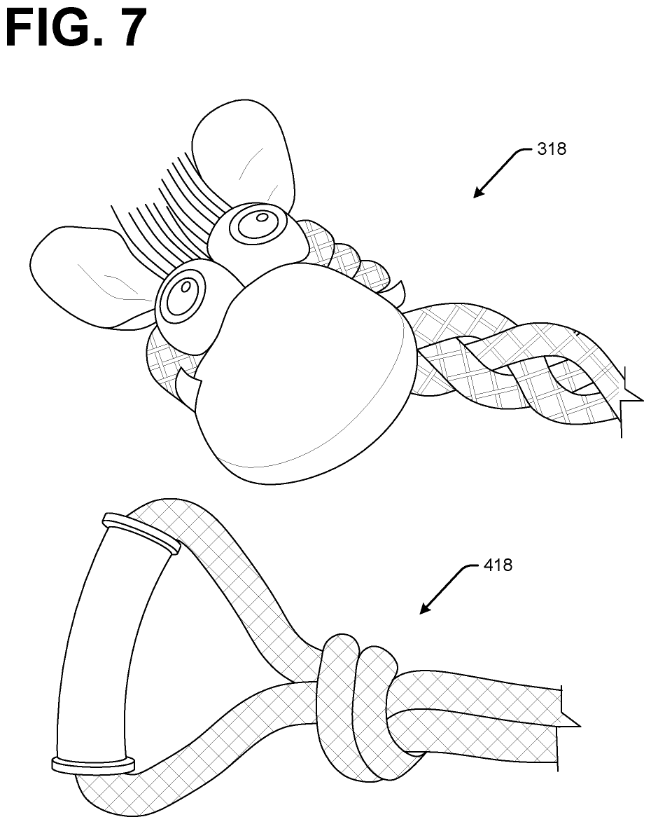

FIGS. 3-6 show various examples of different designs of the connector body of an interchangeable pet toy 10. It is noted that in FIGS. 2-5, 100—series and 200—series reference numbers correspond to parts already described in FIG. 1. The description of like components may not be repeated again herein for brevity. In FIGS. 3-5, the connector body 112 is shaped in the form of a bone. In FIG. 6, the connector body 212 is shaped like a stick. Still other sizes and/or shapes may be provided. FIG. 7 shows examples of other toys or accessories (e.g., plush 318 and handle 418) which may be provided for the interchangeable pet toy. In FIG. 7, the looped end portions have been omitted from the drawings. Still other toys or accessories may be provided. It is also noted that the toys or accessories need not be made of knotted rope.

The looped connections (14a, 14b in FIG. 1) may be sewn to the connector body (12 in FIG. 1). Likewise as shown in FIGS. 3-5, the looped connections 114a, 114b and 214a, 214b are shown as these may be sewn to the connector body. In an example, the looped connections may also include reinforcement stitching 215 (see, e.g., FIG. 6), wherein additional stitching provides a stronger securement of the looped connections to the connector body. This may be particularly desired when the interchangeable pet toy 10 is provided for larger dogs that may pull harder (e.g., during a game of tug of war).

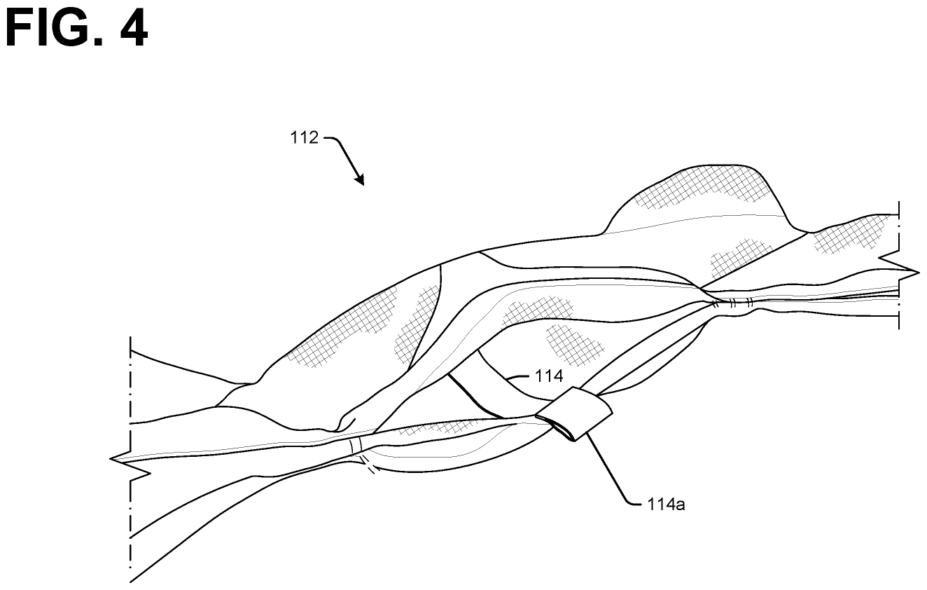

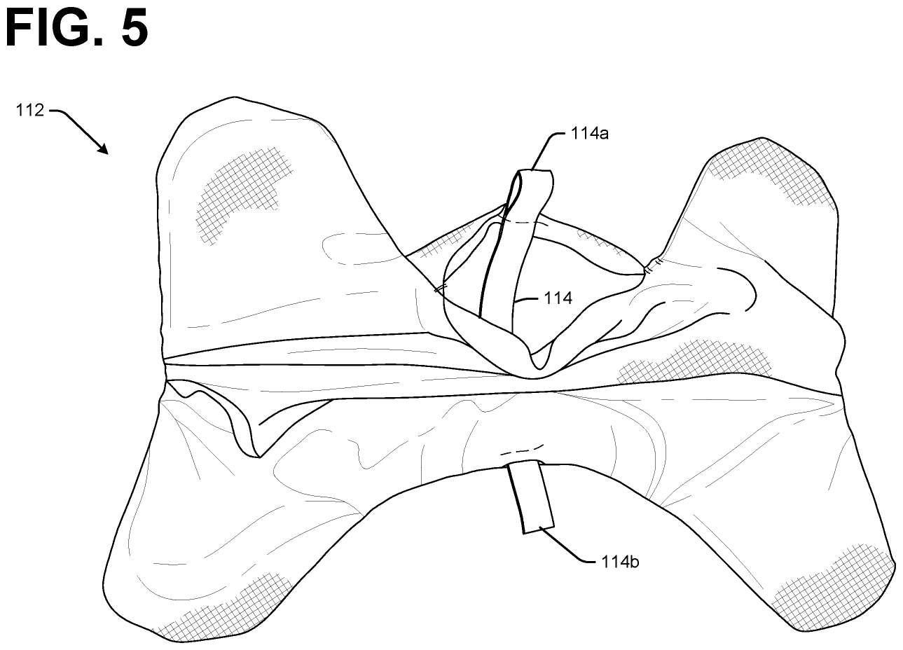

In an example, the looped connections are formed on opposite ends of a single strap. This can be seen in the drawings, for example with reference to the strap 114 in FIGS. 4 and 5. The strap 114 extends through (e.g., fed through during manufacture) an interior cavity of the connector body 112. The looped connections 114a, 114b extend outside of the connector body 112. In the example shown, the looped connections 114a, 114b are provided on a single strap sewn to the connector body 112. However, multiple straps may also be provided (e.g., separate straps for each looped connection).

It is noted that the toys may be constructed as stuffed plush toys, balls, ropes, rubber objects, and any other suitable material for a dog or other pet to chew and pull on, similar to existing toys in the market. However, the interchangeable pet toy 10 disclosed herein incorporates a novel attachment system to enable the swift and hassle-free addition of other toys or accessories. This attachment system is enabled by a single strap 114 (e.g., a continuous strip of nylon webbing) that runs through the center of the toy and forms loops on its exterior surface.

The continuous strip of nylon webbing ensures the integrity and strength of the attachment system. This strap 114 acts as the foundation for attaching customer-selected accessories to the toy. Accessories can be easily attached to the loops on the exterior by utilizing either rope and knots or a specially designed rubber connector. The attachment system allows for a strong and secure connection, capable of withstanding rough play activities like tug-of-war, and allowing for the quick and secure attachment of external accessories and customization of the pet toy.

The strap 114 or continuous strip of nylon webbing ensures the integrity and strength of the attachment system, enabling a durable connection for rough play. The modular design and quick attachment system enable efficient manufacturing, allowing for tailor-made toys to meet individual customer preferences. The attached accessories and the attachment system are designed to be soft and safe for pets, ensuring a pleasant and secure play experience.

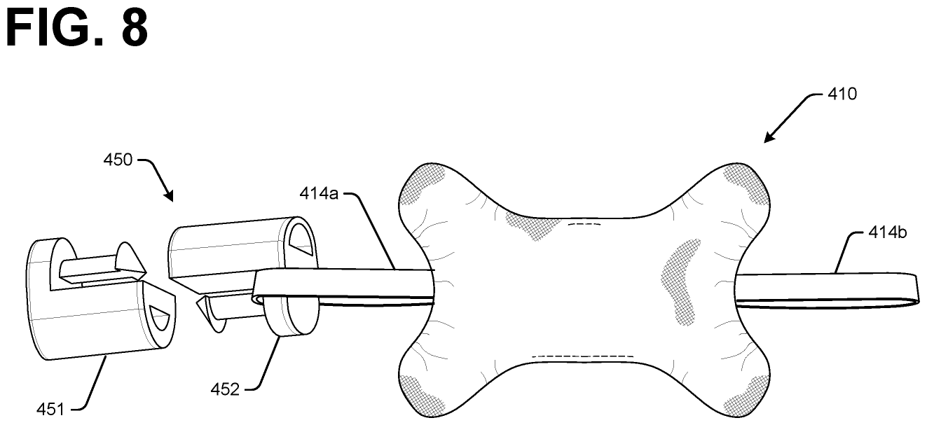

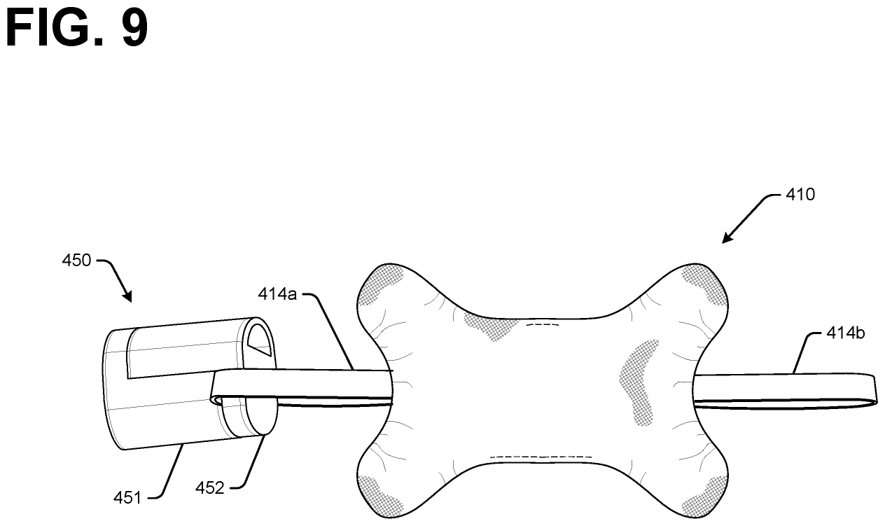

FIGS. 8 and 9 show an example of another interchangeable pet toy 410 with an interconnection member 450. The interchangeable pet toy 410 is similar to that already described above, but has longer looped connections 414a and 414b. The longer looped connections 414a and 414b enable the interchangeable pet toy 410 to be looped around the interconnection member 450 in an open configuration, and then the interconnection member 450 is closed. For example, parts 451 and 452 are snap fit together to lock the interconnection member 450 onto the looped connection 414a.

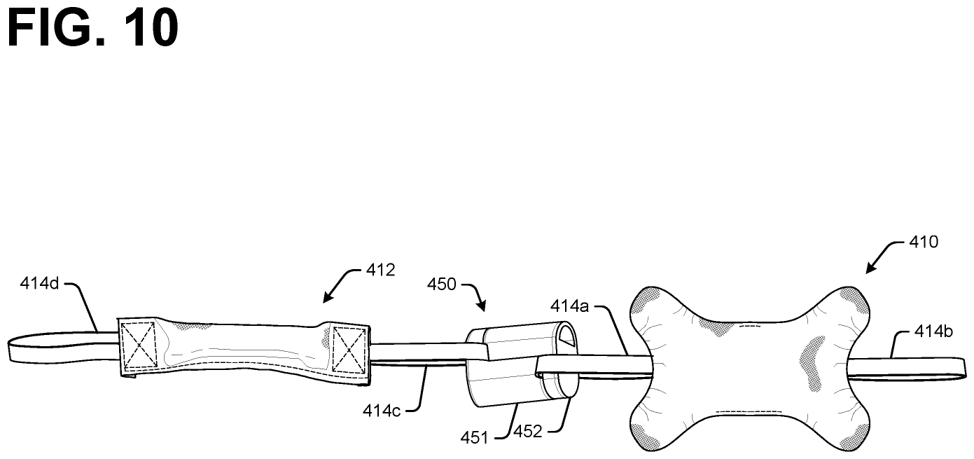

FIG. 10 shows the example interchangeable pet toy 410 of FIGS. 8 and 9 as it may be connected in a daisy-chain with another example interchangeable pet toy 412 having looped connections 414c and 414d. Other examples are also contemplated as being within the scope of the disclosure, as will be readily understood by those having ordinary skill in the art after becoming familiar with the teachings herein. The scope of the claims is not intended to be limited to these examples. Any number, size, and configuration of pet toys may be interconnected with any number, size, and configuration of other pet toys.

It is noted that the examples shown and described are provided for purposes of illustration and are not intended to be limiting. Still other examples are also contemplated.

1. An interchangeable pet toy, comprising:
a connector body having at least one looped connection;
a first toy or accessory having a first looped end portion; and
a second toy or accessory having a second looped end portion;
wherein the first looped end portion of the first pet toy extends through and is interconnected with the at least one looped connection of the connector body to secure the first toy or accessory to the connector body, and wherein the first looped end portion of the first toy or accessory is removed from the connector body for replacement with the second toy or accessory.

2. The interchangeable pet toy of claim 1, wherein the first toy or accessory is a handle.

3. The interchangeable pet toy of claim 1, wherein the first toy or accessory is a ball or other toy.

4. The interchangeable pet toy of claim 1, wherein the connector body is interchangeable with a plurality of different toys or accessories.

5. The interchangeable pet toy of claim 1, wherein the at least one looped connection is sewn to the connector body with reinforcement stitching.

6. The interchangeable pet toy of claim 1, further comprising a first looped connection and a second looped connection, both sewn to the connector body.

7. The interchangeable pet toy of claim 6, wherein the first looped connection and a second looped connection are formed on opposite ends of a single strap.

8. The interchangeable pet toy of claim 7, wherein the single strap is fed through an interior cavity of the connector body.

9. The interchangeable pet toy of claim 8, wherein the first looped connection and the second looped connection extend outside of the connector body.

10. The interchangeable pet toy of claim 9, wherein the single strap is sewn to the connector body.

11. An interchangeable pet toy, comprising:
a connector body having at least a first looped connection and a second looped connection; and
a plurality of toys or accessories, each of the toys or accessories having a looped end portion;
wherein the looped end portion of the toys or accessories is fed through and interconnected with either of the first looped connection or the second looped connection of the connector body to secure the toys or accessories to the connector body, and wherein the looped end portion of the toys or accessories is removed from the connector body to replace the toys or accessories with other toys or accessories.

12. The interchangeable pet toy of claim 11, wherein the connector body is interchangeable with a plurality of different types of toys or accessories.

13. The interchangeable pet toy of claim 11, wherein the first and second looped connections are sewn to the connector body with reinforcement stitching.

14. The interchangeable pet toy of claim 11, wherein the first and second looped connections are formed on opposite ends of a single strap.

15. The interchangeable pet toy of claim 14, wherein the single strap extends through an interior portion of the connector body.

16. The interchangeable pet toy of claim 15, wherein the first and second looped connections extend outside of the connector body.

17. An interchangeable and configurable pet toy, comprising:
a first connector body having at least a first looped connection and a second looped connection;
a second connector body having at least one looped connection; and
at least one toy or accessory having a looped end portion; and
at least one extension having a looped end portion on each side;
wherein the looped end portion of the at least one toy or accessory is connected to the first looped connection of the first connector body;
wherein the at least one extension is connected between the second looped connection of the first connector body and the at least one looped connection of the second connector body.

18. The interchangeable pet toy of claim 17, wherein the first and second connector bodies are interchangeable with a plurality of different types of toys or accessories.

19. The interchangeable pet toy of claim 17, wherein the first looped connection and the second looped connection of the first connector body are formed on a single strap extending through an interior cavity of the connector body.

20. The interchangeable pet toy of claim 19, wherein the first looped connection and the second looped connection extend outside of the interior cavity of the connector body.
